(19) United States
(12) Patent Application Publication
(10) Pub. No.: US 2025/0350111 A1
(43) Pub. Date: Nov. 13, 2025

(54) Advanced Mobile Power Station with Multi-Source Charging Capability

(71) Applicant: TAILAI TING, POMONA, CA (US)

(72) Inventor: TAILAI TING, POMONA, CA (US)

(21) Appl. No.: 18/661,473

(22) Filed: May 10, 2024

(51) Int. Cl. H02J 1/08; H02J 7/00; H02J 7/02

(52) U.S. Cl. CPC H02J 1/08; H02J 7/0042; H02J 7/02

(57) ABSTRACT

An innovative mobile power station designed to accept and simultaneously charge from multiple AC and DC power sources, including AC generators of various brands and frequencies, as well as diverse DC sources like power tool batteries, vehicle batteries, and solar panels. The power station features a control unit that optimally manages power intake and battery charging, significantly enhancing operational flexibility and efficiency.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### FIELD OF INVENTION

The invention pertains to the field of electrical power systems, particularly to a mobile power station capable of simultaneous multi-source AC and DC charging, including from varied branded generators and multiple types of DC sources.

### BACKGROUND OF THE INVENTION

Current mobile power stations generally accept only a single type of AC or DC input, limiting their usability with different power generation devices and in various operational environments. Moreover, they cannot charge simultaneously from multiple AC sources of differing frequencies or from diverse DC sources such as power tool batteries, vehicle batteries, and solar panels.

### SUMMARY OF THE PRESENT INVENTION

The invention addresses these limitations by providing a mobile power station that supports multiple AC and DC inputs, can charge from these inputs simultaneously, and is compatible with AC sources from different brands with varying electrical frequencies. This flexibility allows for continuous operation across various settings and power availability scenarios, significantly enhancing the usability and appeal of the mobile power station in commercial and emergency contexts.

### BRIEF DESCRIPTION OF THE DRAWINGS

FIG. 1 is a perspective view of the mobile power station detailing the input ports and output ports.

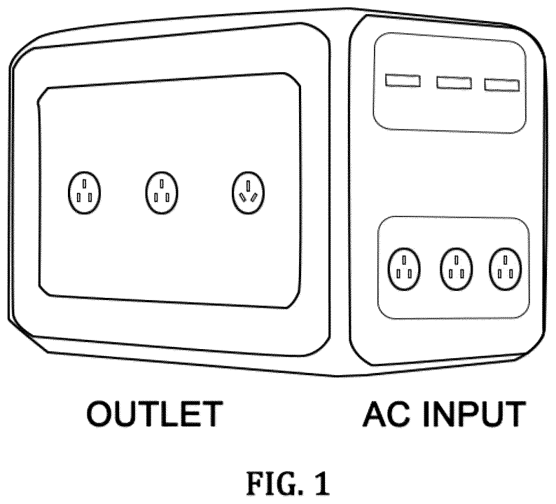

### DETAILED DESCRIPTION OF THE INVENTION

The mobile power station includes a robust housing containing a battery storage unit, multiple AC input ports capable of accepting different frequencies, and multiple DC input ports. Each AC input port connects to a frequency converter linked to a central control unit programmed to manage and harmonize inputs from generators of different brands and frequencies. The DC input ports are designed to connect with various DC power sources, including power tool batteries, 12V car batteries, and solar panels.

### Operational Details

The control unit dynamically manages the power input, optimally charging the battery storage unit from the available AC and DC sources. It includes safety protocols to prevent overcharging and optimize power flow, ensuring efficient energy storage and prolonged battery life.

### Technical Advantages

This power station's capability to integrate and optimize multiple and simultaneous power inputs from various AC and DC sources represents a significant advancement over existing technologies, offering greater flexibility and reliability.

1. A mobile power station, comprising:
a. Multiple AC input ports for connecting to AC power sources of varying frequencies;
b. Multiple DC input ports for connecting to various types of DC power sources including power tool batteries, 12V car batteries, and solar panels;
c. A control unit configured to manage charging from said AC and DC inputs simultaneously.

2. The mobile power station of claim 1, wherein the AC input ports are configured to accept power from AC generators of different brands and frequencies and convert said power to a frequency suitable for charging the battery storage unit.

3. The mobile power station of claim 1, further comprising frequency converters associated with each of the AC input ports, each configured to adjust the frequency of incoming AC power to an optimal frequency for battery charging.

4. The mobile power station of claim 1, wherein the DC input ports are designed to automatically detect the type of connected DC power source and adjust the charging parameters accordingly.
